(19) United States
(12) Patent Application Publication
(10) Pub. No.: US 2005/0030392 A1
(43) Pub. Date: Feb. 10, 2005

(54) Method for eliminating blooming streak of acquired image

(76) Inventors: Kujin Lee, Cupertino, CA (US); Poong Hyun Seong, Lincroft, NJ (US); Seung Jun Lee, Seoul (KR); Jong Hyun Kim, Seoul (KR)

Correspondence Address: Kujin LEE, 20430 Via Paviso E32, Cupertino, CA, 95014, US

(21) Appl. No.: 10/645,716

(22) Filed: Aug. 7, 2003

(51) Int. Cl. H04N 5/217

(52) U.S. Cl. 348/241

(57) ABSTRACT

A method for eliminating blooming streak of an acquired image is capable of eliminating blooming streaks in the acquired image photographing an object together with a light source by mutually replacing the blooming streaks in the acquired image with a partial image corresponding to the blooming streaks from other acquired image, wherein each image is acquired by cameras with changing the arrangement direction of the CCD sensors of the cameras.

This application is entitled to the benefit of Provisional Patent Application Ser. No. 60/267,757 filed on Feb. 9, 2001 in the U.S.A.

### TECHNICAL FIELD

The present invention relates to a method for eliminating blooming streaks of an image by composing the images of an object photographed by a camera together with a light source, and in particular to a method for eliminating blooming streak of an acquired image capable of photographing an object with one or more camera module(s) which has/have a plurality of CCD sensors of which directions are differently arranged each other, and of eliminating blooming streaks formed by the light source from the acquired images by composing the acquired images.

### BACKGROUND ART

Generally, when an object is photographed by a camera under a light source such as the sun, the light is often incident to the camera lens and thereby the photographed image of the object includes a white streak therein. Similarly, when the camera photographs an object together with other light sources, not the sun, the image taken under the lights source is included the white streak.

Therefore, when the image are photographed and formed under the light source by a camera, then the white streak occurred in the image by the light of the light source. The technical reason of the white streak formed in the images is that basically the camera adopts a CCD (Charge Coupled Device) sensors.

Meanwhile, this phenomenon appearing the white lines in the image is called as “blooming phenomenon of CCD sensor” and the white lines are called as “blooming streak”.

In order to prevent the blooming phenomenon from the image, conventionally, the CCD sensors with anti-blooming gate are manufactured with a relatively lower sensing capability so as not to occur the blooming streak when the camera photographs an object together with the light source. Therefore, the camera adopting the CCD sensors manufactured according to the prior art method has relatively low sensing capability, too.

Meanwhile, when an image is acquired for usage of a geographical information to a local area, the image must have an accuracy and a precision without appearing any the blooming streak.

However, when omni-directionally photographing to obtain the geographical information, since the objects of the photographing exist omni-directionally and can be various, such as sky, various buildings in a downtown, road and wood, etc., the blooming phenomenon inevitably occurred in the image due to the light source exists in some direction of the scene.

Therefore, it is needed to develop a certain apparatus of an optical structure and a method of the same which are capable of eliminating the blooming streak in the acquired image.

### DETAILED DESCRIPTION OF THE INVENTION

The main object of the present invention is to provide a method for eliminating blooming streak of an acquired image for eliminating a blooming streak caused by a light source in the acquired image by composing a first image of an object together with a light source and a second image of the same object photographed by a camera with changing the arrangement direction of CCD sensors of the camera.

In order to achieve the object of the present invention, there is provided a method for eliminating a blooming streak of an acquired image, comprising the steps of: acquiring a first image of an object formed a first blooming streak by a light source therein, the first image of the object is photographed by a first photographing means together with the light source; differently positioning between the arrangement direction of CCD sensor of a second photographing means and the arrangement direction of CCD sensor of the first photographing means; acquiring a second image of the object formed a second blooming streak by the light source therein, wherein a formed angle of the second blooming streak is different from that of the first blooming streak and the second image is photographed by the second photographing means; searching and selecting a partial image in the second image, wherein the partial image corresponds to the first blooming streak in the first image; and generating a third image without the blooming streak by replacing the first blooming streak with the partial image in the second image, which corresponds to the first blooming streak and is not bloomed.

In the method according to the present invention, the first photographing means and the second photographing means as a type of multi camera module comprises a plurality of cameras which are symmetrically arrange at a specific point in a plane to omni-directionally photograph, wherein each camera has a viewing angle allocated by 360 divided by the number of the cameras, wherein the first photographing means and the second photographing means are electrically connected to a computer vision system.

In the method according to the present invention, the multi-camera module further comprises one or more camera(s) placed at the top thereof so that the camera(s) can photograph an object upward.

In the method according to the present invention, the computer vision system comprises: first frame grabbers each of which is electrically connected to each of the cameras of the multi-camera module, to grab photographed images by frames; an exposure calculator electrically connected to the frame grabbers, to calculate exposure of each camera, based on the grabbed images by frames; an exposure signal generator electrically connected to each camera, to transmit information about the exposure as a signal on the basis of the exposure calculated by the exposure calculator; a storage means electrically connected to each frame grabber, to store images photographed by the cameras according to photographing location and photographing time; a GPS sensor to sense the photographing location and photographing time as data; a distance sensor and a direction sensor for respectively sensing the distance and direction of the image photographed by each camera; an annotation entering unit electrically connected to the GPS sensor, the distance sensor and the direction sensor, to calculate location and time corresponding to each frame based on the sensed data, the annotation entering unit being electrically connected to the storage means to enter the calculated location and time in each frame as annotation; and a trigger signal generator electrically connected between the storage means, and electrically connected either the exposure signal generator, or camera selectively and electrically connected between the distance sensor and the annotation entering unit, the trigger signal generator to selectively transmits a trigger signal to the exposure signal generator or camera selectively and the annotation entering unit in order that the cameras start to photograph the objects according to the trigger signal.

In the method according to the present invention, the computer vision system further comprises a plurality of light intensity sensors electrically connected to the exposure calculator to allow the exposure calculator to be able to calculate the exposure amount of each camera based on external light intensity.

In the method according to present invention, the storage means is one of digital storage devices including a hard disk, compact disk, magnetic tape and memory.

In the method according to the present invention, the storing means further comprises an audio digital converter electrically connected to the storage means, the audio digital converter converting an audio signal sensed by an audio sensor into a digital signal as an audio clip to correspondingly attach to give the storage means a unique audio clip corresponding to each image or image group to be stored in the storage means.

In the method according to the present invention, the storage means further comprises a video camera electrically connected to the storage means via a second frame grabber for grabbing photographed moving pictures by frames, to give the storage means a unique video clip corresponding to each image or image group to be stored in the storage means.

### BRIEF DESCRIPTION OF THE DRAWINGS

The present invention will become better understood with reference to the accompanying drawings which are given only by way of illustration and thus are not limitative of the present invention, wherein;

FIG. 1 is a flow diagram of a method for eliminating a blooming streak of an acquired image according to the present invention;

FIG. 2 is a view illustrating an elimination procedure of a blooming streak according to the present invention;

FIG. 3 is a block diagram illustrating a first construction of a computer vision system for implementing a method for eliminating a blooming streak of an acquired image according to the present invention;

FIGS. 4A through 4E are perspective views illustrating the constructions in which a multiple camera module is stacked in various forms according to the present invention;

FIG. 5 is a block diagram illustrating a second construction of a computer vision system for implementing a method for eliminating a blooming streak of an acquired image according to the present invention;

FIG. 6 is a view illustrating a multiple camera module which is installed in a housing according to the present invention;

FIG. 7 is a view illustrating a first construction that a computer vision system and a multiple camera module are mounted in a mobile means;

FIG. 8 is a view illustrating a second construction that a computer vision system and a multiple camera module are mounted in a mobile means;

FIG. 9 is a view illustrating the generation of panorama image by cylindrical projection according to the present invention; and

FIG. 10 is a view illustrating the generation of panorama image by spherical projection according to the present invention.

### DETAILED DESCRIPTION OF THE PREFERRED EMBODIMENTS

The method for eliminating a blooming streak of an acquired image and according to the present invention will be described with reference to the accompanying drawings.

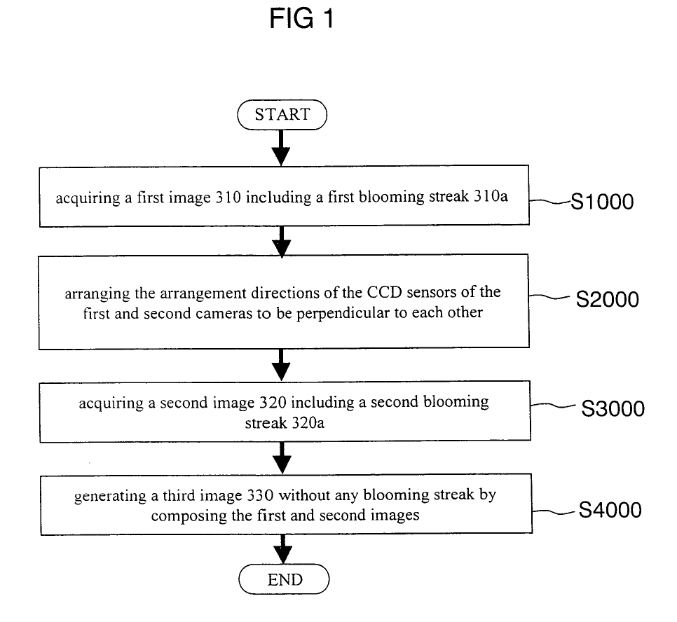

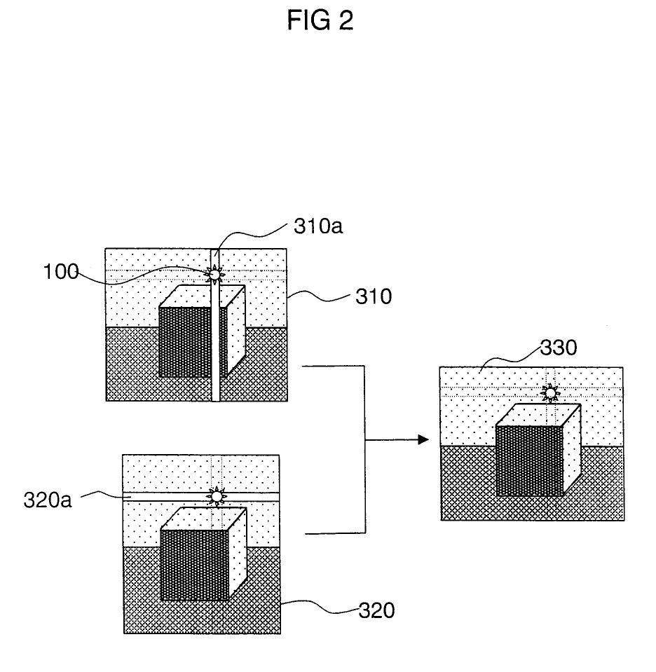

FIG. 1 is a flow diagram of a method for eliminating a blooming streak of an acquired image according to the present invention and FIG. 2 is a view illustrating an elimination procedure of a blooming streak according to the present invention.

As shown in FIGS. 1 and 2, an image photographing an object 200 together with a light source 100 comprises a blooming streak due to the light source 100. The blooming streak can be removed in the image by a method for eliminating a blooming streak that photographs the same object 200 with changing the photographing angle, and for composing the photographed images each other

The method for eliminating a blooming streak of an acquired image according to the present invention will be explained as below:

First, when an object 200 is photographed together with a light source 100, a first image 310 is acquired in Step S1000. Here, the first image 310 includes a first blooming streak 310a due to the light from the light source, which is generated in a vertical direction of the first image 310. This is caused by the reason that the arrangement direction of the CCD sensor of the first photographing means is vertically arranged.

Then, the arrangement direction of the CCD sensor of the second photographing means is arranged to be perpendicular to that of the CCD sensor of the first photographing means in Step S2000.

The second photographing means photographs the object together with the light source 100 and acquires second images 320 in Step S3000. Here, the second image 320 includes a second blooming streak 320a of which direction is perpendicular to that of the first blooming streak 310a. This is caused by the reason that the arrangement direction of the CCD sensor of the first photographing means is perpendicular to that of the CCD sensor of the second photographing means.

The first and second images 310 and 320 acquired by the first photographing means and the second photographing means are stored into the computer vision system 30 as a format of digital data. Here, the computer vision system 30 further comprises an annotation entering unit 35 to store the first and second images 310 and 320 together with annotation associated with the images when the images are stored.

The first and second images 310 and 320 of the same object 200 stored in the computer vision system 30 are photographed by the photographing means with different arrangement direction of the CCD sensor.

As mentioned above, because the first and second images 310 and 320 are photographed by the photographing means together with the light source 100, each first and second blooming streak 310a and 320a are included therein.

Here, the first and second blooming streak 310a and 320 a in each image are perpendicular to each other, because the images are photographed and acquired by the first and second photographing means each of which the arrangement direction of the CCD sensors are perpendicular to each other.

Finally, a third image 330 is acquired by composing the first and second images 310 and 320 so as to remove the first and second blooming streaks 310a and 320a each other. Here, the third image 330 is generated as the first blooming streak 310a in the first image 310 is replaced with a partial image of the second image 320 corresponding to the first blooming streak 310a. Namely, the first blooming streak 310a of the first image 310 is searched in the second image 320 and selected corresponding partial image therein. Then, the selected partial image in the second image 320 is replaced with the first blooming streak 310a in the first image 310 in Step S4000.

Therefore, the quality of the third image 330 can be high without the first blooming streak.

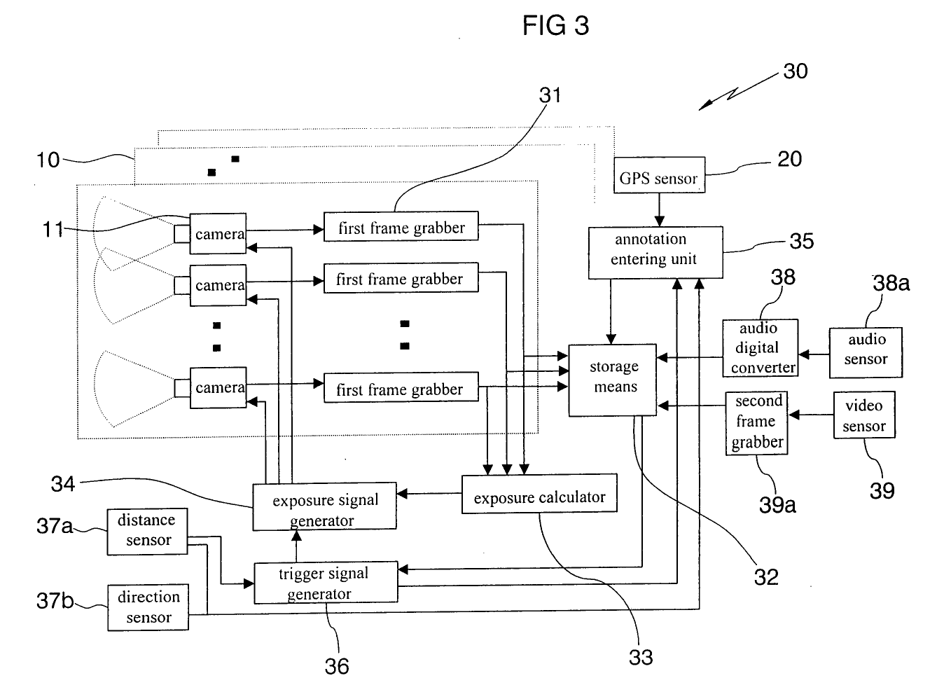

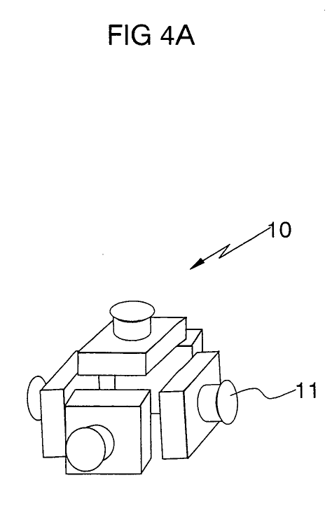

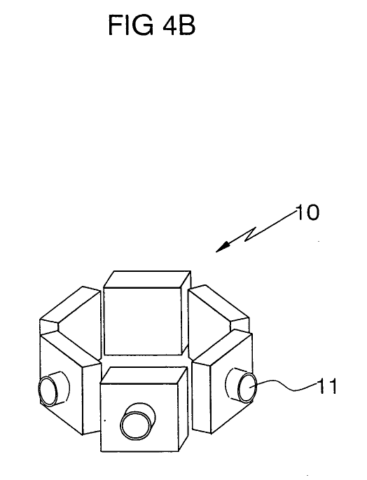

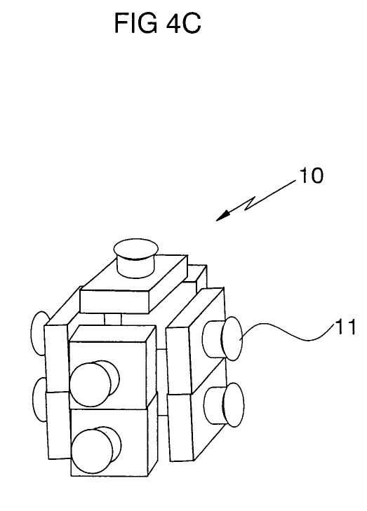

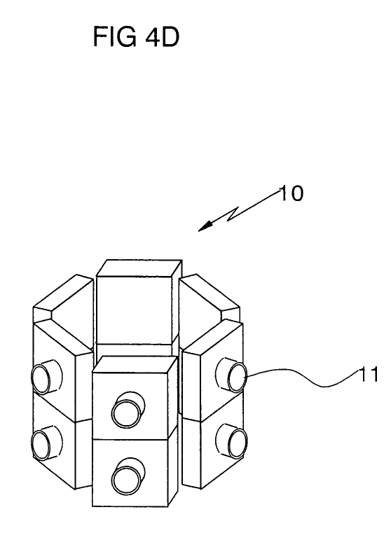

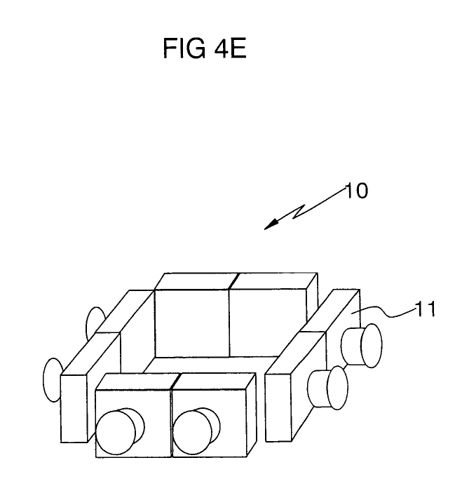

FIG. 3 is a block diagram illustrating a first construction of a computer vision system for implementing a method for eliminating a blooming streak of an acquired image according to the present invention and FIGS. 4A through 4E are perspective views illustrating the constructions in which a multi camera module is stacked in various forms according to the present invention.

As shown in FIGS. 3, 4A to 4E, the computer vision system 30 electrically connected with the first and second photographing means stores the photographed images and controls the exposure amount of the photographing means. The first photographing means and the second photographing means comprise one or more multi camera module(s) 10 including a plurality of cameras 11, for example 4 or 6, each of which takes charge of a viewing angle allocated by 360° divided by the number of the camera 11 in order to omni-directionally photograph the surrounding objects.

As shown in FIG. 4E, the multi camera module 10 can be horizontally arranged with a pair of cameras 11 which are facing the same direction. Therefore, in order to omni-directionally photograph, all the pairs of cameras 11 are symmetrically arranged at a specific point in the plane. Also, the multi camera module 10 of FIG. 4E is stacked in the direction of height and forms a multi layers. When the multi camera modules 10 are stacked, each optical center of the cameras 11 of the multi camera modules 10 are lined up in he direction of height.

Further, the multi camera module 10 can install a camera 11 thereon, so that the camera 11 can photograph upward.

The computer vision system 30 comprises a first frame grabber 31 for grabbing an image by frames, an exposure calculator 33 electrically connected with the first frame grabber 31 for calculating the exposure amount of the camera 11, and an exposure signal generator 34 for transmitting the calculated exposure signal to each camera 11.

In addition, the storage means 32 electrically connected with the first frame grabber 31 stores the grabbed images as a digital data therein. Further, the storage unit 32 is electrically connected with an annotation entering unit 35 which enters an photographing location information such as photographing time, photographing location and photographing direction as an annotation data into each image.

The annotation entering unit 35 is electrically connected with a GPS sensor 20 for inputting a location information of each image as a annotation data.

The GPS sensor 20 received current photographing location information from GPS satellites transmits a photographing location information into the annotation entering unit 35 when it receives the photographing location information of the multi camera module 10 from GPS satellites, and thereby the annotation entering unit 35 uses the received information as an annotation data.

However, the GPS sensor 20 may have a certain limit for receiving a location information from satellites due to signal block by buildings or woods.

In order to overcome the above problems, the computer vision system 30 further includes a distance sensor 37a and a direction sensor 37b. Therefore, if the GPS sensor 20 does not effectively data from the satellites, the data detected by distance sensor 37a and the direction sensor 37b may be used as a secondary information.

The operation of the computer vision system 30 will be explained.

The image photographed by each camera 11 in the multiple camera module 10 is grabbed by frames by the first frame grabber 31. The first frame grabber 31 is independently connected with each camera 11 for each layer, assuming that one multiple camera module 10 is recognized as one layer.

The frame-based image grabbed by each first frame grabber 31 is stored in the storage means 32 and also is transmitted to the exposure calculator 33 electrically connected with the first frame grabber 31. The photographed image is stored in digital data in the storage means 32 such as a hard disk, compact disk, magnetic tape, memory and so on. The image transferred from the first frame grabber 31 to the exposure calculator 33 is analyzed by the exposure calculator 33, and thereby the exposure amount of each camera 11 is calculated. The calculated exposure amount is transferred to the exposure signal generator 34 which is electrically connected with the exposure calculator 33. The exposure signal generator 34 transfers a signal corresponding to the exposure amount of the camera 10 to each camera 11.

At this time, a geographical information such as a photographing location, time, distance, direction, etc., of each camera 11 may be obtained by the GPS sensor 20 capable of obtaining a location information from satellites in real time. Since the distance sensor 37a and the direction sensor 37b are further provided in addition to the GPS sensor 20, it is possible to obtain a photographing distance and direction. Here, the GPS sensor 20 receives a location data from satellites in real time and confirms a location information in real time.

When the effectiveness of the GPS signal is significantly decreased, the signals of the distance sensor 37a and the direction sensor 37b are used as a secondary information.

The annotation entering unit 35 is electrically connected with the GPS sensor 20, the distance sensor 37a and the direction sensor 37b to receive the geographical information data detected by the sensors 20, 37a and 37b.

The annotation-entering unit 35 is electrically connected with the GPS sensor 20, distance sensor 37a and direction sensor 37b to receive geographical information data sensed by the sensors 20, 37a and 37b.

The annotation-entering unit 35 enters annotation corresponding to each frame to be stored in the storage means 32. The annotation is photographing location and photographing time of each frame of photographed images. The images in which annotations are entered by frames are stored in the storage means 32. Here, the storage means 32 stores the images transmitted from the camera 11 after the camera 11 photographing or at the same time when the camera 11 photographs and transmits thereto. The operation of storing the images in the storage means 32 and the operation of photographing by the camera 11 can be performed sequentially or in parallel. In addition, it is also required that sensing operations of the sensors 20, 37a and 37b related with the storing and photographing operations, and the operations such as calculation and interchange of exposure information with respect to the camera 11 are carried out in relation to each other.

The photographing and storing operations and the operations related thereto start when a trigger signal generator 36 transmits the trigger signals is electrically connected between the storage means 32 and the exposure signal generator 34.

The trigger signal generator 36 generates a trigger signal to initiate transmission of exposure information of the exposure signal generator 34, performed before photographing by the camera 11, and the storing operation of the storage means 32. Also, The trigger signal generator 36 is also electrically coupled connected between to the distance sensor 37a and the annotation entering unit 35.

When annotating photographing location and time, geographical information transmitted from the GPS sensor 20 to the annotation entering unit 35 is used first.

If the effectiveness of the GPS sensor 20 is deteriorated, annotation entering unit 35 uses signal sensed by the distance sensor 37a and direction sensor 37b to calculate location information.

When the speed of storing speed of the images in the storage means 32 is slower than the speed of acquiring speed of the images, the trigger signal of the trigger signal generator 36 can be temporarily blocked to the storage means 32 in order that for image storing operation paces with to catch up the image acquiring operation.

Meantime, the storage means 32 further connects with an audio digital converter 38 or a video camera 39, so that is electrically connected to the storage means 32 to give a corresponding audio clip or video clip as an accessory data attaches to each image or group of images to be stored in the storage means 32. The audio digital converter 38 converts an analog audio signal sensed by an audio sensor 38a into a digital signal to store it in the storage means 32 as digital data. The video camera 39 takes a motion picture of the objects at a photographing location or a photographing interval of a location segment of photographing distance, corresponding to photographed image or image groups. The photographed motion pictures are grabbed by frames by a second frame grabber 39a to be stored in the storage means 32.

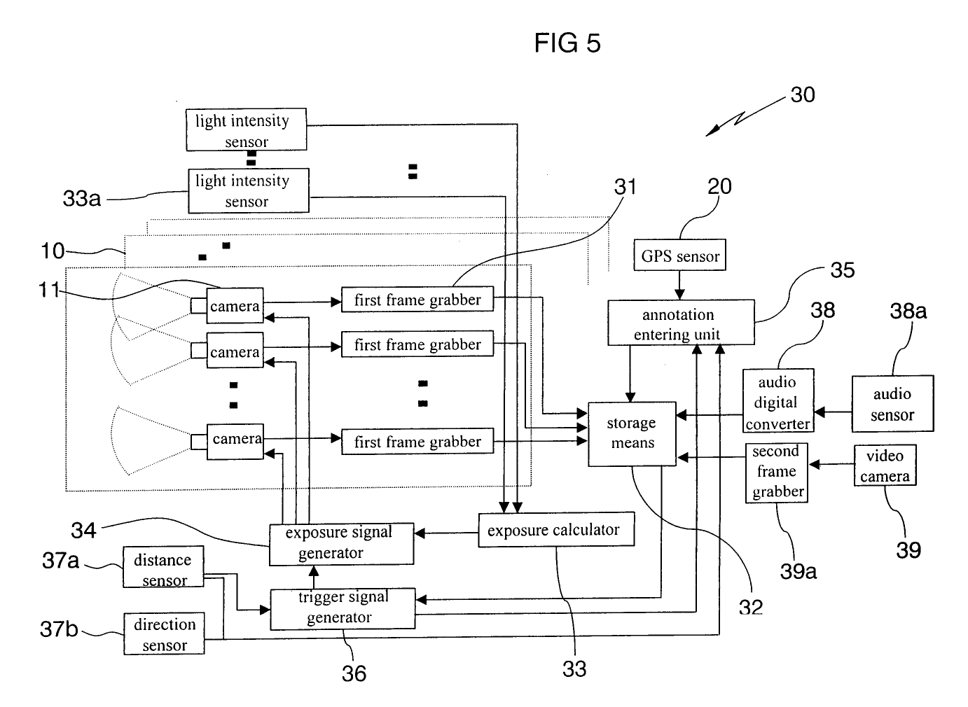

FIG. 5 is a block diagram illustrating a second construction of a computer vision system for implementing a method for eliminating a blooming streak of an acquired image according to the present invention.

Referring to FIG. 5, the exposure calculator 33 calculates the exposure of each camera 11. The calculated exposure information is transmitted to each camera 11 by the exposure signal generator 34. Here, light intensity sensors 33a are electrically connected to the exposure calculator 33 to sense light intensity around the photographing location or in front of the object 200 to be photographed.

Accordingly, a light intensity sensing signal transmitted from the light intensity sensor 33a is delivered to the exposure calculator 33 that calculates the exposure of each camera 11. The calculated exposure is transmitted as a signal to each camera 11 through the exposure signal generator 34. Each camera 11 controls exposure amount thereof based on the exposure signal.

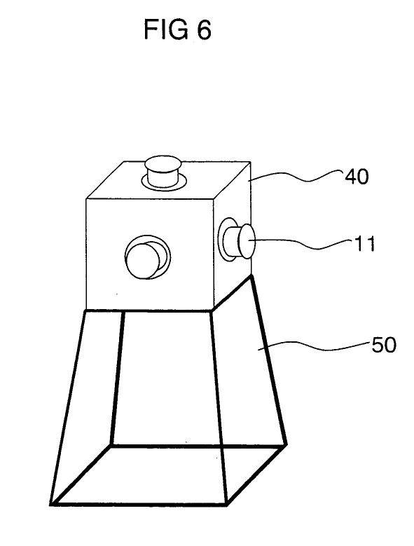

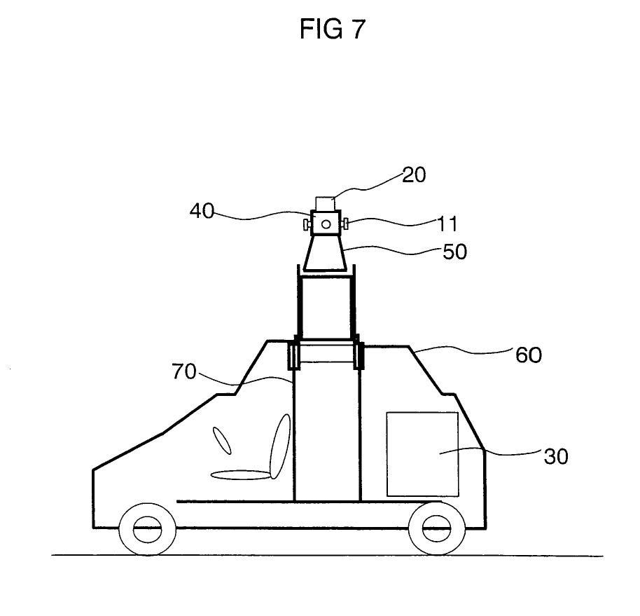

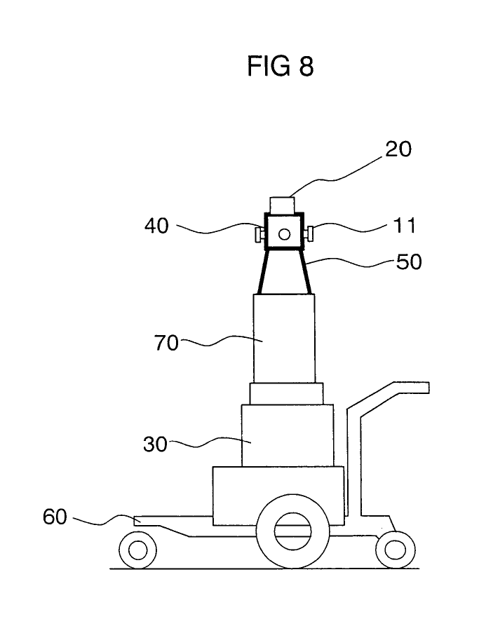

FIG. 6 is a view illustrating a multiple camera module which is installed in a housing according to the present invention, FIG. 7 is a view illustrating a first construction that a computer vision system and a multiple camera module are mounted in a mobile means, and FIG. 8 is a view illustrating a second construction that a computer vision system and a multiple camera module are mounted in a mobile means.

Referring to FIGS. 6 to 8, the multi-camera module 10 and computer vision system 30 are mounted on a mobile means 60 to be given a mobile function to photograph the object 200 while moving. The multi-camera module 10 is set inside a specific housing 40 to protect its body and expose only the lens part to the outside. The bottom of the housing 40 is supported by a jig 50 to be raised to a specific height, and the housing 40 is moved up and down by an elevator 70 set in the mobile means 60. The mobile means 60 is preferably an automobile having a driving engine or a cart capable of being moved by the human power or self-propelled by its own power supply.

The automobile is used when the camera module photographs the an object while moving on the drivable road and the cart is used in case where it takes a picture of an the object 200[number 200 didn't appear on the drawing] while moving on the sidewalk or hallway of indoor area.

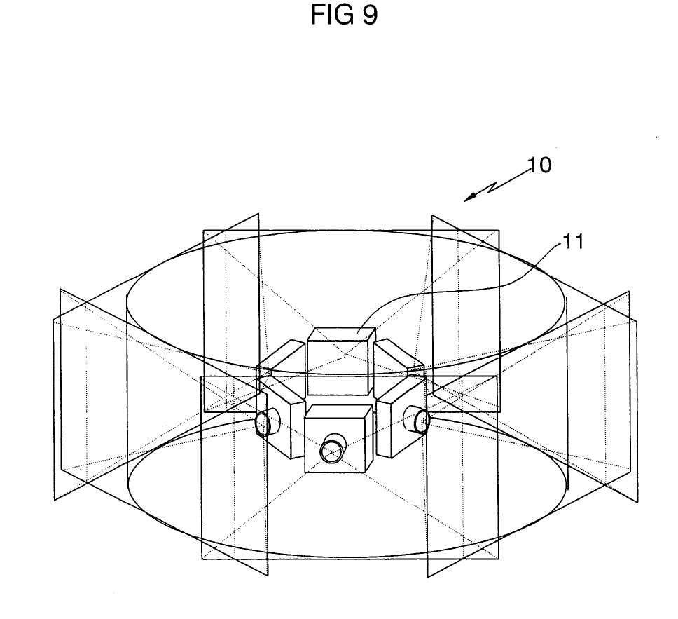

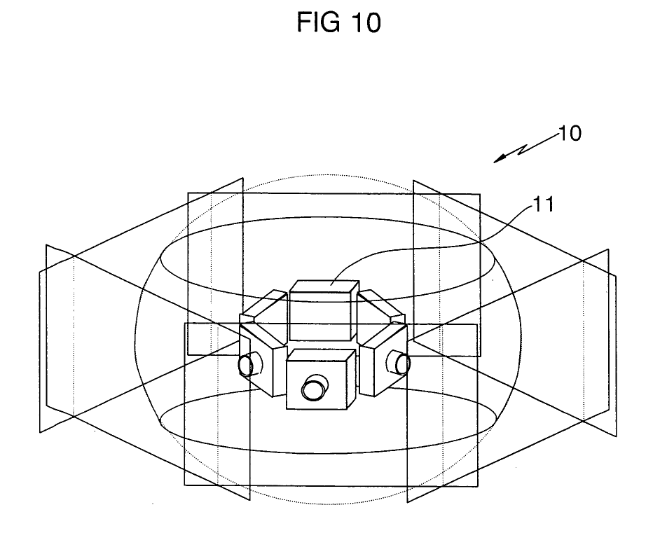

FIG. 9 illustrates a panorama stitching principle by cylindrical projection according to the invention and FIG. 10 illustrates a panorama stitching principle by spherical projection according to the invention. Namely, FIGS. 9 and 10, show an exemplary panorama image generation by cylindrical projection or spherical projection from hexagonal collection of images. Cylindrical or spherical images are mapped onto the surface of cylinder or sphere before it is presented, then the cylinder or sphere is presented to the user as if it is observed from the center of cylinder or sphere through the window of the viewer software on computer monitor. Dotted lines in FIG. 9 show coverage of projection from optical center of each camera.

### INDUSTRIAL APPLICABILITY

As we have mentioned above, a method for eliminating blooming streak of an acquired image can effectively eliminate the blooming streak in the acquired images together with a light source and thereby acquire high quality images for use of other information such as geological information data.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalence of such meets and bounds are therefore intended to be embraced by the appended claims.

1. A method for eliminating a blooming streak of an acquired image, comprising the steps of:
acquiring a first image of an object formed a first blooming streak by a light source therein, the first image of the object is photographed by a first photographing means together with the light source;
differently positioning between the arrangement direction of CCD sensor of a second photographing means and the arrangement direction of CCD sensor of the first photographing means;
acquiring a second image of the object formed a second blooming streak by the light source therein, wherein a formed angle of the second blooming streak is different from that of the first blooming streak and the second image is photographed by the second photographing means;
searching and selecting a partial image in the second image, wherein the partial image corresponds to the first blooming streak in the first image; and
generating a third image without the blooming streaks by replacing the first blooming streak with the partial image in the second image, which corresponds to the first blooming streak and is not bloomed.

2. The method of claim 1, wherein the first photographing means and the second photographing means as a type of multi camera module comprising a plurality of cameras which are symmetrically arrange at a specific point in a plane to omni-directionally photograph, wherein each camera has a viewing angle allocated by 360° divided by the number of the cameras, wherein the first photographing means and the second photographing means are connected to a computer vision system.

3. The method of claim 2, wherein the multi-camera module further comprising one or more camera(s) placed at the top thereof so that the camera(s) can photograph an object upward.

4. The method of claim 2, wherein the computer vision system comprising:
first frame grabbers each of which is electrically connected to each of the cameras of the multi-camera module, to grab photographed images by frames;
an exposure calculator electrically connected to the frame grabbers, to calculate exposure of each camera, based on the grabbed images by frames;
an exposure signal generator electrically connected to each camera, to transmit information about the exposure as a signal on the basis of the exposure calculated by the exposure calculator;
a storage means electrically connected to each frame grabber, to store images photographed by the cameras according to photographing location and photographing time;
a GPS sensor to sense the photographing location and photographing time as data;
a distance sensor and a direction sensor for respectively sensing the distance and direction of the image photographed by each camera;
an annotation entering unit electrically connected to the GPS sensor, the distance sensor and the direction sensor, to calculate location, direction and time corresponding to each frame based on the sensed data, the annotation entering unit being electrically connected to the storage means to enter the calculated location and time in each frame as annotation; and
a trigger signal generator electrically connected between the storage means, and electrically connected either the exposure signal generator, or camera selectively and electrically connected between the distance sensor and the annotation entering unit, the trigger signal generator to selectively transmits a trigger signal to the exposure signal generator or camera selectively and the annotation entering unit in order that the cameras start to photograph the objects according to the trigger signal.

5. The method of claim 4, wherein the computer vision system further comprising a plurality of light intensity sensors electrically connected to the exposure calculator to allow the exposure calculator to be able to calculate the exposure amount of each camera based on external light intensity.

6. The method of claim 4, wherein the storage means comprising one of digital storage devices including a hard disk, compact disk, magnetic tape and memory.

7. The method of claim 4, wherein said storing means 32 further comprising an audio digital converter electrically connected to the storage means, the audio digital converter converting an audio signal sensed by an audio sensor into a digital signal as an audio clip to correspondingly attach to give the storage means a unique audio clip corresponding to each image or image group to be stored in the storage means.

8. The method of claim 4, wherein the storage means further comprising a video camera electrically connected to the storage means via a frame grabber for grabbing photographed moving pictures by frames, to give the storage means a unique video clip corresponding to each image or image group to be stored in the storage means.
